(19) United States
(12) Patent Application Publication
(10) Pub. No.: US 2008/0308519 A1
(43) Pub. Date: Dec. 18, 2008

(54) Beverage Container

(76) Inventors: Peter Antony Farrar, Leeds (GB); John Hein, Leeds (GB); Anthony Henry Joseph Fraser, Rutland (GB); Benjamin Bryan Mortimer, Leeds (GB)

Correspondence Address: MEADWESTVACO CORPORATION, 1021 MAIN CAMPUS DRIVE, CENTENNIAL CAMPUS, RALEIGH, NC, 27606, US

(21) Appl. No.: 11/570,959

(22) PCT Filed: Jul. 6, 2005
(86) PCT No.: PCT/GB2005/002656

§ 371 Date: Aug. 27, 2008

(30) Foreign Application Priority Data
Jul. 7, 2004 (GB) 0415204.7

(51) Int. Cl. B65D 41/04; B65D 51/16; B65B 7/28; B23P 19/04

(52) U.S. Cl. 215/329; 220/361; 215/44; 29/700

(57) ABSTRACT

A beverage container for the storage of a carbonated drink comprising a container body (10; 70) including an opening (11; 70A) and removable closure means for closing said opening, the closure means comprising a foil (12; 72) which provides a gas tight seal for said opening and a collar (13, 14; 71) for securing the foil to the container body. The collar may be a cylindrical component provided on its own (51; 60) or as part (93A) of another component, e.g. a cap (93). The collar may also be provided around the skirt of a cap or a skirt of a cap may be provided around the collar. The foil (72) may also be secured to the collar (71).

### TECHNICAL FIELD

The present invention relates to beverage containers, and particularly relates to containers for supplying carbonated beverages to consumers. The invention has particular utility for the storage and supply of carbonated and other sparkling drinks, but may also be used with other types of drinks.

### PRIOR ART

For many years there has been a desire among drinks suppliers and container manufacturers to provide practical wide-mouth beverage supply containers which consumers may drink from comfortably in the same manner as from a drinks glass or other drinking vessel, particularly in relation to carbonated drinks such as beers, etc. Despite the tremendous advantages that such a beverage container would provide for drinks suppliers, container manufacturers and consumers alike, no successful beverage container that fulfils these aims has yet been produced. Consequently, bottles and ring-pull cans currently remain the main practical beverage supply containers for consumers. This is because there are significant technical problems associated with wide-mouth containers to overcome, and no practical solution to the problems has successfully been devised. The present invention aims to provide a practical beverage container.

### SUMMARY OF THE INVENTION

A first aspect of the present invention provides a beverage container for the storage of a carbonated drink comprising a container body including an opening and removable closure means for closing said opening, the closure means comprising a foil which provides a gas tight seal for said opening and a collar for securing the foil to the container body.

References to foil herein are to be understood to refer to a thin membrane and includes impervious laminates comprising one or more layers which give the foil strength and one or more layers for attaching the upper and/or lower surface of the foil to another article. Such foils are widely used in other fields. Where the foil is to be secured by induction heating, an electrically conductive layer is required. This is usually a metallic layer and most commonly a layer of aluminium. The electrically conductive layer is typically provided with one or more plastic coatings, e.g. of polyethylene, which melt when the electrically conductive layer is heated to bond the foil to an article held in contact therewith. Such foils can be bonded to both glass and plastic articles.

The container is typically formed of a plastics material, e.g. polyethylene terephthalate (PET), or of glass. The container is preferably shaped to resemble a conventional drinking vessel, e.g. a beer glass.

The foil is preferably secured to the container body, e.g. by being welded thereto by induction heating.

The collar preferably comprises a generally cylindrical member with a general circular opening at each end thereof. In a preferred embodiment, the foil extends across one of said openings. Preferably, the collar is a snap-fit onto the container body, which preferably has a projecting rim or lip around the opening thereof over which the collar snap-fits.

In a preferred arrangement, the closure means comprises a cap for fitting over the collar; the cap being secured to the collar by relative rotation therebetween. The cap and collar are preferably provided with mutually engageable thread portions. In a first position, the cap prevents removal of the collar from the container body and thus secures the closure means to the container body.

When the cap is in a second position, the collar can be prised off the container body. Preferably, the foil is secured to the collar such that, as the collar is prised off the container body, the foil is progressively peeled away from the container body.

In a preferred embodiment, the collar has a plurality of slots therein which enable it to expand to an extent sufficient to be fitted to and/or prised from the container body. Alternatively, the collar has an interruption or a gap in its circumference so it can be radially expanded to be fitted to and/or removed from the container body and releasable fastening means for closing said interruption or gap and preventing radial expansion of the collar in the closed position.

As indicated above, in a preferred arrangement, the foil is secured to the collar or to the cap so that, as the cap and/or collar is prised off the container, the foil is progressively peeled away from the container.

The collar may comprise a skirt depending from the perimeter of a circular component, the collar and circular component together having the form of a cap. The skirt may have at least one interruption or slot therein so the skirt can flex radially outwards to permit the collar to be fitted around the container body and releasable securing means for bridging the interruption or slot to prevent such outward radial flexing so as to secure the skirt about the container body.

In some embodiments the collar may be in the form of an incomplete ring or band the ends of which can be joined together to form a ring. A fastening device used for joining two ends of such a band may simply secure the two ends together to form a complete ring or it may be capable of pulling the ends of the band nearer to each other so it can be tightened about the container body. Such a fastening device may comprise a part which secures the two ends of the band together by means of an over-centre mechanism which puts and holds the ring under tension.

The collar may be provided with one or more tabs adjacent weakened areas such that the tab(s) can be pulled so as to break or tear the collar open. Such tabs may be formed to resemble a conventional ring pull, and may be arranged to pierce the foil so as to initiate venting of the container.

Collars such as those described above may also be used to secure a foil to a container body directly without a cap.

The cap and/or collar may be made from a range of materials but are preferably formed from a plastics material such as polypropylene (PP) or polyethylene (PE) and may be formed by injection moulding. The collar may also be formed of other materials, e.g. of metal.

Venting means are preferably provided to allow pressure within the container to be vented prior to complete removal of the cap and/or the foil. If the foil is attached to the container, controlled venting may be provided as the foil is peeled off the container, the foil being progressively peeled away from the container from one side of the container mouth to the other side thereof.

The foil is preferably secured to the container in a manner capable of withstanding internal pressures of 1-2 bar or greater (as might arise if a carbonated drinks container is subject to high temperatures), e.g. up to about 6 bar.

As well as preventing the egress of gas, the foil also protects the container from ingress of gas, so helps prevent contamination of the beverage and prevent it becoming stale. With such a foil, the beverage container can have a shelf-life of at least 9 months (as typically required for beers and other carbonated drinks sold in containers).

The foil may also provide tamper evidence in that if the foil is intact it provides the consumer with reassurance that the product has not been tampered with or previously opened. This function is further enhanced if the cap is formed of a transparent material.

A second aspect of the present invention provides a beverage container comprising a container body including an opening and removable closure means for closing said opening, the closure means comprising a foil which seals said opening, a cap for fitting to the body over the foil and a collar for fitting around the cap to secure the cap to the container body.

In a preferred arrangement, tamper evident means are provided on the closure means to provide visual indication as to whether the closure means has been opened or tampered with. The tamper evident means preferably comprises a frangible connection between the cap and the collar which is ruptured when the collar is loosened or removed.

One form of tamper evident means comprises one or more flaps, or other features, each of which is connected to the cap via a frangible connection and which is moveable into engagement with the collar, once the collar has been fitted around the cap, so it can be secured to the collar, e.g. by being welded thereto. This connection to the collar is stronger than said frangible connection so that movement of the collar relative to the cap causes the frangible connection to break. The flaps and collar may be provided with mutually engageable parts, e.g. a projecting peg which fits within a hole, to help connect them together. A plurality, e.g. four, of such flaps or features are preferably provided spaced around the periphery of the cap.

In another embodiment, the cap is provided with a tamper evident feature which, when connected to the ring, inter-engages with another part of the cap so that relative movement of the ring which causes a frangible connection between the tamper evident feature and the cap to break also initiates rupture of the cap via said inter-engagement. This may render the cap easier to peel off the container body and/or initiate rupture of the foil, e.g. to provide venting of the container. The cap may be provided with one or more thin or weak areas where such rupture can be initiated. Alternatively, or additionally, said features may extend through the collar to engage with another part of the cap so as to prevent inadvertent or premature loosening of the collar by inhibiting rotational movement therebetween. However, when sufficient force is applied to the collar, rupture of the cap and/or collar is initiated to facilitate removal of the cap from the container.

In some cases, the tamper evident means may comprise part of the collar which ruptures or opens up the collar to enable it to be removed. The collar may be a continuous ring, for instance having camming means or thread forms on the internal surface thereof as mentioned above and/or having one or more weakened or rupturable sections as also discussed above. Many other forms of collar may, however, be used to help secure the cap to the container body. The collar may, for instance, be a shrink-fit about the skirt of the cap. In another arrangement, the diameter of the collar may be adjustable so it can be tightened about the skirt once fitted in place.

As indicated above, the closure means may be arranged to provide venting of the container as it is removed from the container. Venting preferably occurs in a controlled manner upon initial movement of the collar relative to the cap and before the cap is free to be removed (so as to avoid missiling of the cap). Controlled venting may be provided by piercing the foil prior to it being removed and/or as the foil starts to be peeled off the container.

The cap and/or collar preferably provides physical support for the foil, e.g. by limiting the extent to which it can be distorted by pressure increases within the container and/or by reinforcing the connection between the foil and the container. The cap and/or collar preferably lies over the perimeter of the foil around the periphery of the opening and thus assists in holding the foil in contact with the container. In some cases this may also provide sufficient obstruction to limit bowing out of the foil due to internal pressure but, preferably, the cap extends across the entire foil both to provide further obstruction to deflection of the foil, particularly at the centre thereof, but also to protect the foil against damage from physical contact with external objects which might puncture the foil and/or reduce its integrity. The cap and/or collar thus strengthens and/or protects the connection of the foil with the container and provides puncture protection for the foil.

In a further embodiment, the cap preferably comprises a skirt depending from a top part, the skirt being designed to fit over the exterior of the container body adjacent the opening thereof. The collar preferably fits around the exterior of said skirt so as to prevent movement of said skirt away from the container and thereby inhibits removal of the cap from the container body. Part of the skirt preferably fits beneath a radially outwardly projecting rim or other form of protrusion on the container body and is preferably a snap-fit therewith. The collar preferably assists in holding said part of the skirt beneath said rim or other protrusion. The inner surface of the collar and/or the outer surface of the skirt may be provided with camming surfaces and/or thread-like formations such that on rotation of the collar relative to the skirt the collar applies a radially inward force upon sections of the skirt to thereby hold the cap on the container body more securely. Such relative movement may be purely rotary and need not involve any axial movement therebetween.

In a preferred arrangement, the foil and cap are first applied to the container body (either together or separately) and the collar then fitted to secure the cap to the container. In a preferred arrangement, it may be necessary to remove and/or break the collar to permit the cap to be removed from the container. Preferably, the foil is removed with the cap and remains bonded thereto as the cap is removed so that it is peeled away from the container as the cap is removed. The cap may be re-used after removal to cover the opening, e.g. by snap-fitting onto the container, to prevent spillage and preserve the freshness of the beverage.

In some cases, the foil may need to be strengthened to increase its puncture resistance and/or a protective component, e.g. a cardboard disk, which extends over the upper surface of the foil may be trapped between the foil and the collar. In such circumstances, the collar preferably covers the upper periphery of the foil as well as extending around the external surface of the container. The foil also preferably has a skirt portion which extends over the external surface of the container adjacent its opening and is preferably crimped in place, e.g. under a lip of the container. The collar may assist with the crimping and/or assist in holding the skirt of the foil in place.

In a preferred arrangement, the foil is attached to the cap so the cap and foil can be removed from the container body together, the foil preferably being arranged to peel away from the container as the cap is prised off. The foil may be attached to the cap by heating the foil, e.g. by induction heating, to melt a plastics layer on the foil whilst it is held in contact with at least part of the cap. Such methods for attaching a foil are well-known in other applications.

Alternatively, or additionally, the foil may be attached to the container around a perimeter of the opening, e.g. by induction heating. Preferably, the attachment to the container, whilst being strong enough to withstand the desired level of pressure within the container, is weaker than the attachment to the cap so that upon removal of the cap, the foil is separated from the container but remains attached to and is removed with the cap.

In another arrangement, the foil may not be attached to the container but seals the opening thereof by simply being held in contact with or pressed onto the container by the cap.

According to another aspect of the invention, there is provided a beverage container for the storage of a carbonated drink comprising a container body including an opening and removable closure means for closing said opening, the closure means comprising a foil which seals said opening, a first component for fitting about the opening of the container body and a second component for securing the first component to the container body, the first or second component (or both) also being arranged to cover said foil.

The first component may be in the form of a cap and the second component in the form of a collar which fits about the cap. Alternatively, the first component may be in the form of a collar and the second component in the form of a cap which fits onto or into the collar. The foil seals the opening and is preferably secured to the first component and/or held in place by the first component whether this is in the form of a cap or in the form of a collar.

According to another aspect of the invention, there is provided a beverage container for the storage of a carbonated drink comprising a container body including an opening and removable closure means for closing said opening, the closure means comprising a first component for releasably mounting on the container body and a second component for attaching to the first component such that in a first position it secures the first component to the container body, and in a second position it permits the first component to be removed whilst remaining attached thereto.

Preferably, the second component once attached to the first component cannot be detached therefrom. Alternatively, the cap may be hingedly connected to the collar, e.g. by a living hinge (i.e. thin web of plastic therebetween).

In a preferred embodiment, when the second component is attached to the first component, it is rotatable in a first direction into said first position and is rotatable in the opposite direction from said first to said second position.

A foil is preferably provided to seal said opening. The foil is preferably attached to the first component so as to be removable therewith when the first and second components are removed from the container body.

The first and second components preferably fit over the container so as to connect to each other around the exterior thereof, however, in other arrangements, they may fit into the opening.

In any of the above arrangements, the opening of the container body is preferably a wide-mouth opening. By a “wide-mouth opening” is meant (at least in its broadest sense) an opening of a size suitable for a person to drink from the container in the same manner as from a drinks glass or similar drinking vessel. That is, in its broadest sense, the wide-mouth opening of the container (for embodiments of the invention having a wide-mouth opening) generally renders the container suitable as a drinking vessel from which a beverage supplied in the container may be conveniently drunk (in contrast to conventional narrow-necked bottles and ring-pull cans which generally are not regarded as comfortable drinking vessels). In practice, this requirement means that the diameter of the wide-mouth opening of the container will normally need to be at least 40 mm, preferably at least 45 mm, and more preferably at least 50 mm. Additionally, an excessively wide opening is generally difficult for the consumer to drink from, and thus the wide-mouth opening preferably has a diameter no greater than 150 mm, more preferably no greater than 100 mm, and especially no greater than 80 mm. A particularly preferred diameter range for the wide-mouth opening is 50 to 80 mm, and examples of particular preferred diameters included 53 mm and 63 mm.

The invention is, however, also applicable to container having a narrower mouth, e.g. in the form of a bottle.

The container body preferably has no thread or thread segments on its exterior. Consequently, the container body preferably is comfortable for a consumer to drink directly from the container body.

As indicated at the beginning of this specification, although the containers described herein may be used for other types of beverages, the invention relates to the storage and supply of carbonated and other sparkling drinks, for example beers, ciders, sparkling wines (including champagne), other fizzy alcoholic beverages, and non-alcoholic fizzy and sparkling beverages, including sparkling water and carbonated soft drinks. It may also be used for the storage of other liquids capable of generating a raised pressure within the container, e.g. due to an increase in temperature and/or the evolution of gas.

According to yet another aspect of the invention, there is provided closure means for a beverage container as described herein. The invention also relates to tamper evident means of closure means for a beverage container as described herein.

In addition, the invention relates to the use of a beverage container of the type described for containing a carbonated beverage and to a method of sealing such a container.

Other preferred or optional features of the invention will be apparent from the following description and from the subsidiary claims of the specification.

### BRIEF DESCRIPTION OF DRAWINGS

The invention will now be further described, merely by way of example, with reference to the accompanying drawings, in which:

FIG. 1 shows an exploded, perspective view of a first embodiment of a beverage container according to the invention;

FIG. 2A is a vertical sectional view though part of the beverage container of FIG. 1 when assembled, and FIG. 2B a plan view of a cap which forms part of the beverage container shown in FIG. 1;

FIG. 3 is an exploded, perspective view of closure means used in a second embodiment of a beverage container according to the invention;

FIG. 4 is a horizontal sectional view through a collar of the closure means shown in FIG. 3;

FIG. 5 is a perspective view of the beverage container of FIG. 3 when assembled;

FIGS. 6A and 6B are horizontal sectional views of a first variant of the closure means shown in FIG. 3;

FIG. 7 is an exploded part view of a second variant of the closure means of FIG. 3 and FIGS. 8 and 9 are perspective and horizontal sectional views thereof when assembled;

FIG. 10 is an exploded perspective view of a collar used in a further embodiment of the invention and FIGS. 11A and 11B illustrate the function of the collar;

FIG. 12 is an exploded perspective view of a further embodiment of the invention;

FIG. 13 is an exploded perspective view of a further embodiment of a beverage container according to the invention;

FIG. 14 is a vertical section through part of the beverage container of FIG. 13;

FIG. 15 is a perspective view illustrating removal of part of the closure means shown in FIGS. 13 and 14;

FIGS. 16A and 16B are vertical sections through part of an embodiment of a beverage container according to the invention in a closed position and when being opened;

FIGS. 17A and 17B are horizontal sections through the closure means of FIG. 16 in a closed position and when being opened;

FIG. 18A is an exploded perspective view of yet another embodiment of a beverage container according to the invention and FIGS. 18B and 18C are a partial perspective view and vertical sectional view thereof when assembled;

FIG. 19A is a partial, exploded view of closure means incorporating tamper evident means suitable for use with containers such as those shown in FIGS. 13-18 and FIGS. 19B and 19C are horizontal sectional views thereof in a closed position and as being opened; and

FIGS. 20A and 20B are horizontal sectional views through further closure means incorporating another type of tamper evident means prior to closure and after closure and FIGS. 20C and 20D are partial perspective views thereof.

The term collar is generally used in the following description in relation to a substantially cylindrical component with an opening at each end thereof and the term cap is used in relation to a component for closing the container comprising a substantially circular upper part and a skirt depending from the periphery thereof. However, it should be noted that in broader aspects of the invention the term collar may also be applied to a substantially cylindrical component which forms the skirt of a cap and is thus open only at one end thereof.

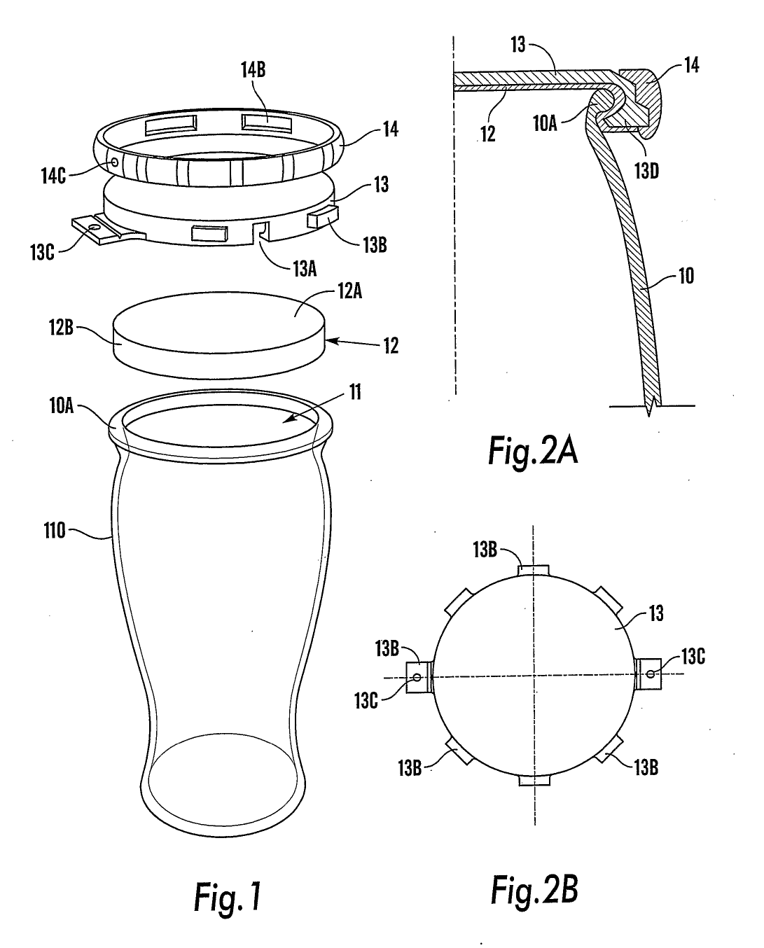

FIG. 1 shows a container 10 with an opening 11 and closure means comprising a foil 12, cap 13 and collar 14.

The container is shaped to resemble a beer glass and has a lip 10A around its opening 11. The foil has a top part 12A and skirt 12B. The cap 13 includes one or more gaps 13A in its periphery, has thread-like formations 13B on its external surface and preferably has tamper evident clips 13B each attached thereto by a living hinge, each clip carrying a projection 13C. The collar 14 comprises threadlike formations 14B on its inner surface for engaging with the thread-like formations 13B of the cap and a recess and hole 14C for receiving each clip 13B and projection 13C.

As shown in FIG. 2A, the foil 12 is held in contact with the lip 10A by the cap 13. The cap 13 has an internal projecting flange 13D which snap-fits beneath the lip 10A and the collar 14 secures the cap 13 to the container 10 by surrounding it so as to prevent the flange 13D disengaging from the lip 10A. The collar 14 is secured to the cap 13 by the respective thread-like formations 13B, 14B thereof.

To remove the closure means, the collar 14 is ‘unscrewed’ from the cap 13 and removed. The cap 13 can then be prised off the container 10, the gaps 13A making it easier to disengage the flange 13D from the lip 10A as they permit the perimeter of the cap 13 to be enlarged as it is lifted off the container 10. The thread-like formations 13B of the cap provide lips that can be lifted to help peel off the cap 13. In the preferred arrangement, the foil 12 is bonded to the underside of the cap 13 so that it lifted at one edge and peeled progressively away from the container 10 as the cap 13 is prised off the container. In contrast, the securement of the cap 13 to the container 10 is effected by screwing the collar 14 onto the cap 13.

In the closed position, each of the flaps 13B is folded up to engage the collar 14 and is preferably then welded thereto so that when the collar 14 is twisted to remove it, the flaps 13B remain attached thereto and tear off the cap 13 along the lines of the living hinges to provide visual tamper evidence.

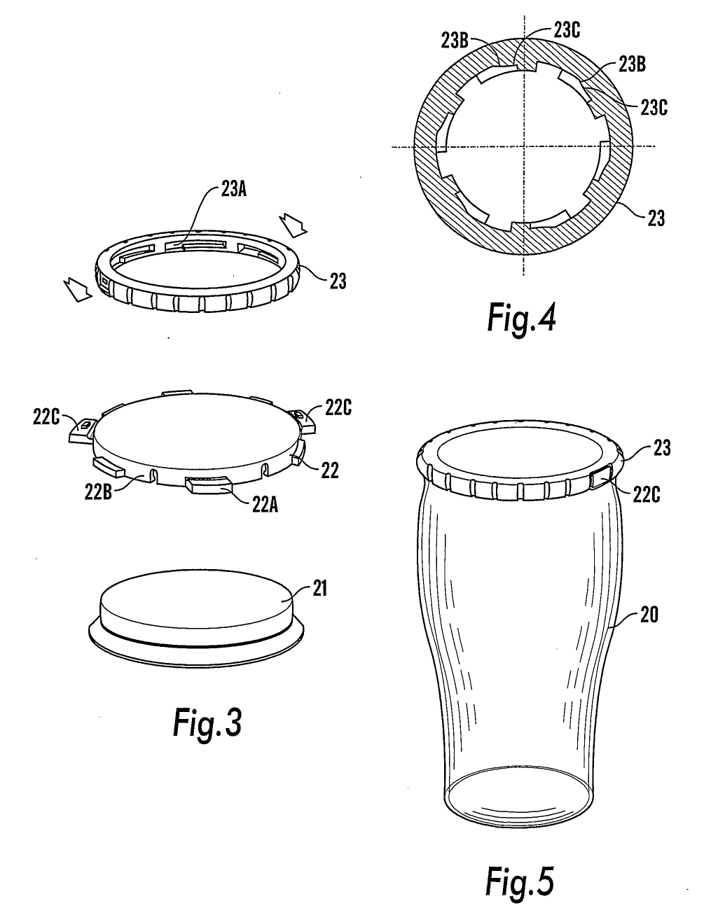

The embodiment shown in FIGS. 3-5 is essentially similar to that shown in FIGS. 1-2 and comprises a container 20, foil 21, cap 22 and collar 23. In this embodiment, the thread-like formations 23A of the collar are provided with ramps 23B, which when engaged with the thread-like formations 22A of the cap 22, force the skirt 22B of the cap radially inwards so it engages the container 10 more securely. A neutral rest position 23C is provided after each of the ramps 23B. FIG. 5 shows the assembled container with a tamper evident flap 22C of the cap folded up to engage the collar 23. Ramps may also be provided on the thread-like formations 22A of the cap 22.

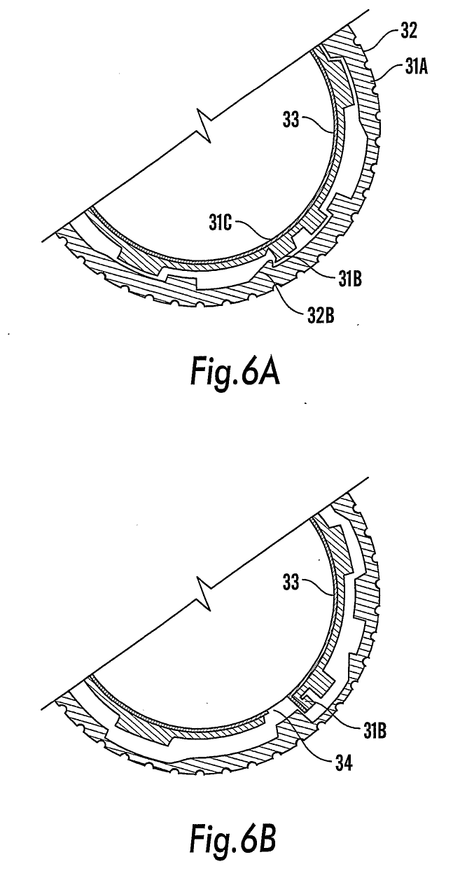

FIGS. 6A and 6B show a variant of the closure means of FIG. 3 in which the thread-like forms 31A and 32A of the cap 31 and collar 32 have projections 31B and 32B which pass each other when the collar is screwed onto the cap to the closed position shown in FIG. 6A but engage when the collar 32 is unscrewed so as to cause rupture of the cap 31 about a weak point 31C to assist in removing the cap 31, provide tamper evidence and/or initiate venting of the container (if the foil 33 is ruptured as well) through a gap 34 so formed in the cap 31. As shown, the thread-like form 31A adjacent the projections 31B, 32B is interrupted to that the part carrying the projection 31B can fold back into a gap in the thread form (as shown in FIG. 6B).

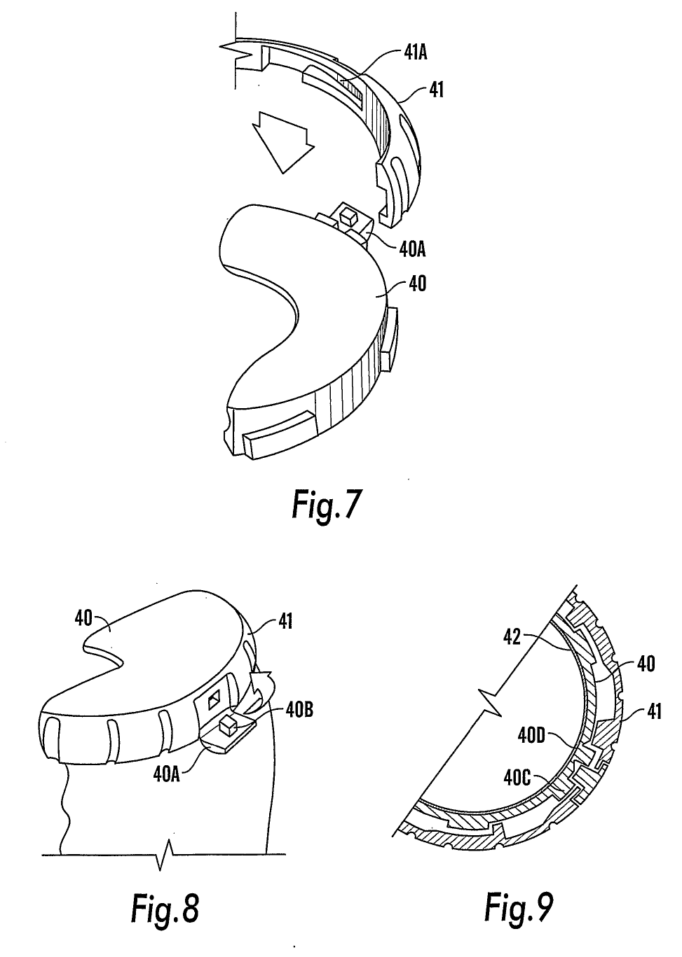

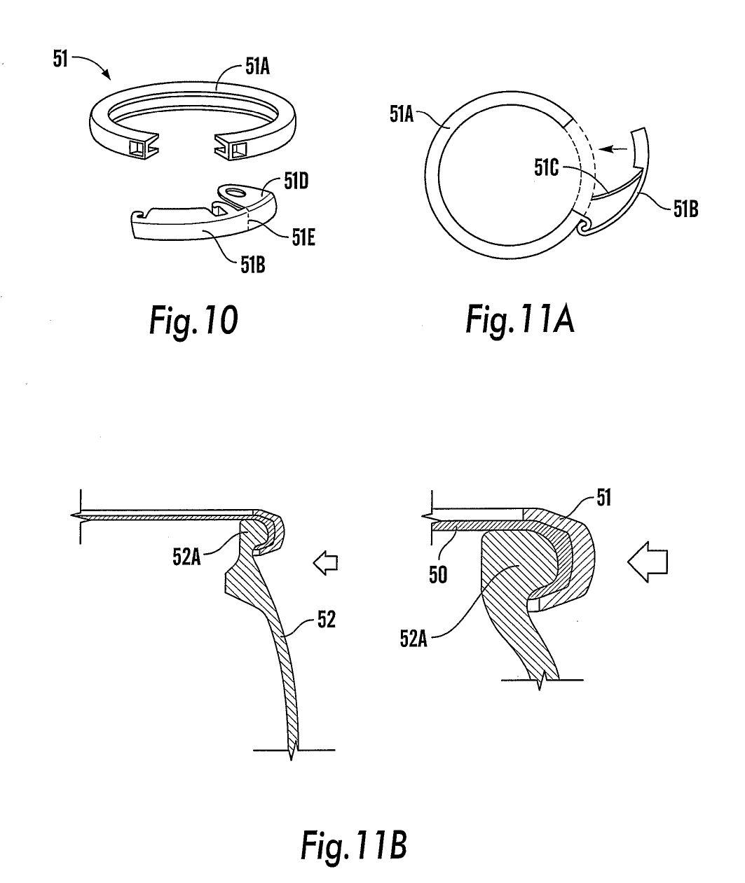

FIGS. 7-9 show a further variant of the cap shown in FIG. 3. In this case, the cap 40 has a tamper evident flap 40A carrying a square projection 40B which when folded up fits through an aperture 41A in the collar 41 and engages an interrupted thread-form 40C of the cap 40. The cap 40 is again provided with a weak point 40D so that when the collar 41 is unscrewed the engagement of the projection 40B with the thread-form 40C causes the cap 40 to rupture at this weak point again to assist in removal of the cap 40, provide tamper evidence and/or initiate venting by rupturing the foil 42.

FIGS. 10-11 illustrate an embodiment of the invention in which the closure means comprise just a foil 50 and a collar 51.

The collar comprises a first part 51A with a gap therein and a second part 51B which can be connected to the first part 51A to join the ends of the first part 51A. The second part 51B hooks to one end of the first part 51A and has an over-centre mechanism 51C such that when moved to the closed position it remains in this position and puts the collar 51 under tension so as to clamp it more securely about the container 52 and foil 50. As shown in

FIG. 11B, the collar 51 is shaped to engage under a lip 52A of container 52 and is arranged to grip the foil 50 tighter as the collar is tightened.

Part 51B is provided with a tab 51D which may be lifted like a conventional ring-pull to break the collar at one or more weak points 51E when it is desired to remove the collar 51 to open the container. This action may also pierce the foil 50.

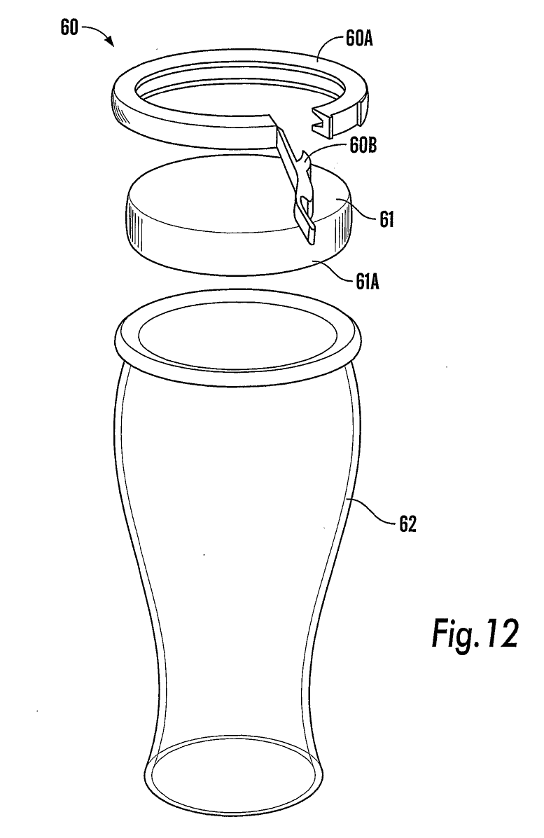

FIG. 12 shows a perspective view of a somewhat similar arrangement. In this case the collar 60 comprises a first part 60A and a second part 60B connected thereto by a living hinge and which is fastened to the first part 60A when moved to the closed position. The foil 61 is provided with a skirt portion 61A to increase its rigidity. The collar 50 is again used to clamp the periphery of the foil 61 to a container 62. The foil 61 may, if desired, be reinforced, in the area it is exposed on the top of the container to increase its puncture resistance. Alternatively, or additionally, a disk (not shown) may be positioned on top of the foil 61 so it is also held in place by the collar 60 to protect the upper surface of the foil 61.

In the embodiments described above in relation to FIGS. 1-9 and FIG. 12, the closure means comprises a collar which fits around a cap to secure the cap to the container body. However, it should be noted that this arrangement can be reversed so that the closure means comprises a cap which fits over a collar to secure the collar to the container body. In both arrangements, a collar-shaped component is used, whether directly or indirectly, to assist in securing the foil to the container body. As indicated above, the skirt of a cap may also be seen as a ‘collar’ in broader aspects of the invention.

The foil may be simply held in place across the opening of the container by the collar but may also be secured to the collar. In a preferred arrangement, the collar may thus comprise a cylindrical component or an annular skirt for fitting about the container opening (internally or externally) with a foil across an aperture therein in the form of a tambourine.

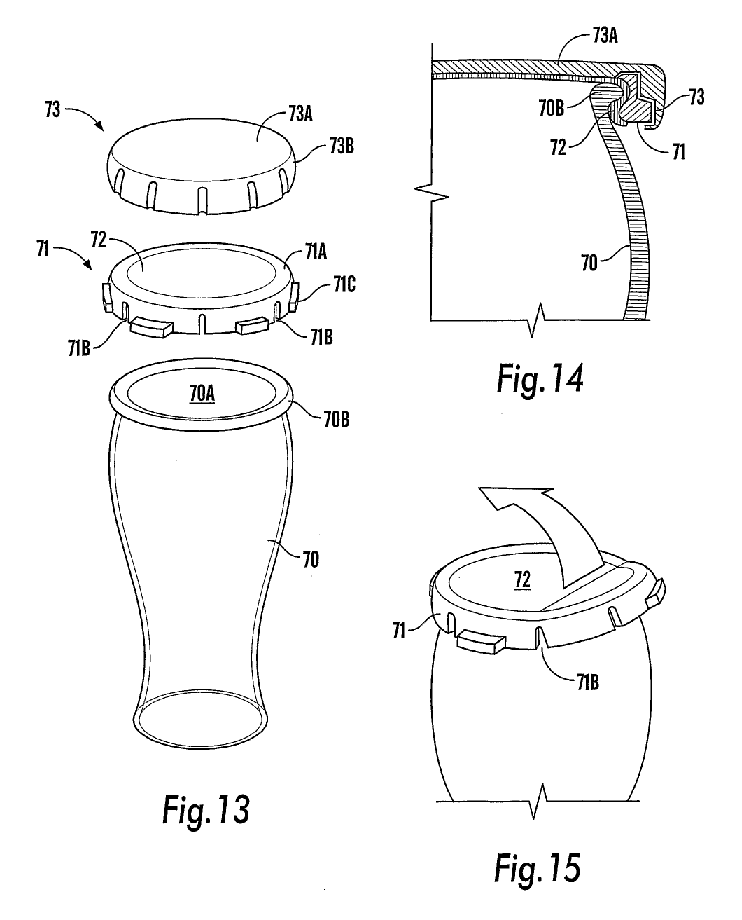

FIGS. 13-15 shows an example of such a container comprising a container body 70, a collar 71 with foil 72 secured thereto and a cap 73. The container has an opening 70A surrounded by a rim with an externally projecting lip 70B.

Collar 71 comprises a generally annular member 71A with a plurality of gaps or slots 71B therein and with thread-like formations 71C on the external surface thereof. The foil 72 is bonded to an upper portion of the annular member 71A. The foil 72 is thus provided across the opening at the upper end of the collar 71.

Cap 73 comprises a top part 73A and a skirt 73B depending therefrom. The internal surface of the skirt 73B is provided with thread-like formations 73C for connecting with the thread-like formations 71C of the collar 71.

The collar 71 is a snap-fit over the lip 70B of the container in a similar manner to the caps described in previous embodiments. The cap 73 also engages with the collar 71 via the thread-like formation in a similar way to that in which the collar described in previous embodiments engages with the cap thereof. The cap 73 is thus rotated relative to the collar 71 to securely fasten the closure to the container. In doing so, the closure also applies pressure to the seal between the foil and the container.

An advantage of the present embodiment is that the collar 71 and foil 72 can be assembled onto the container and the foil bonded thereto prior to the cap 73 being fitted. Foil 72 can thus be heated by direct heating means rather than by induction heating. Direct application of heat and pressure from a welding head can form a more reliable bond than is achievable by induction heating.

FIG. 14 shows the beverage container in the closed position with the top part 73A of the cap covering the foil 72 and the skirt thereof preventing the collar 71B from disengaging with the lip 70B. To open the container, cap 73 is first removed by unscrewing it from the collar 71 so that the collar 71 can be prised off the lip 70B. This is possible as the cut-outs 71B allow the skirt of the collar 71 to flex outwardly and the foil 72 bends as it is peeled off the container 70 (as shown in FIG. 15). The foil 72 is thus progressively peeled away from the container from one side of the container mouth as the collar 71 is prised off the container 70.

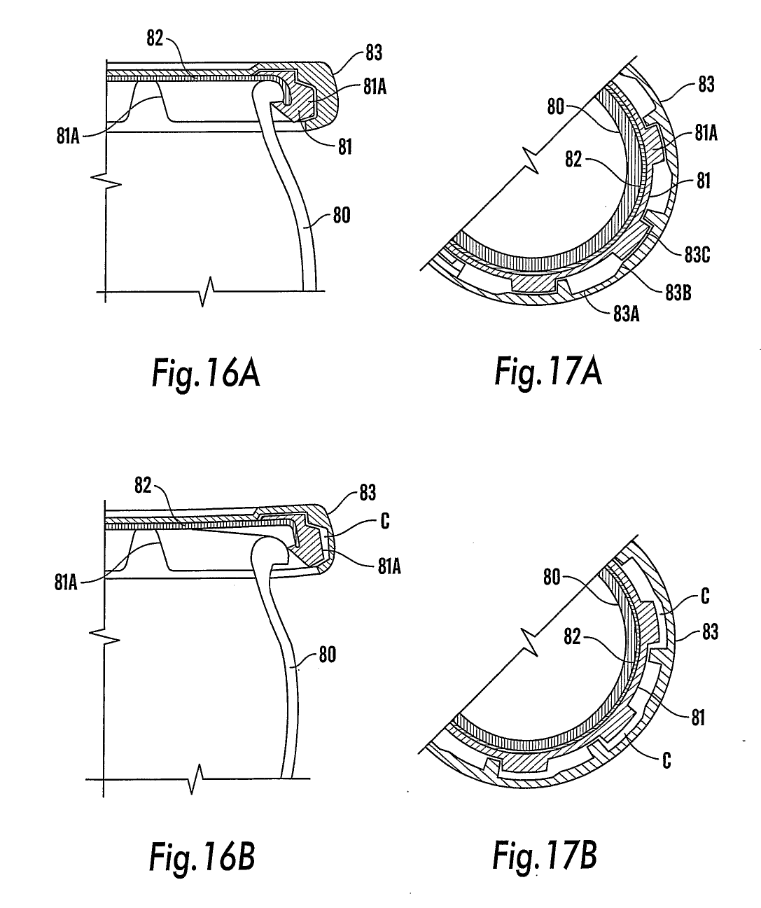

The embodiment shown in FIGS. 16 and 17 comprises a container 80, a collar 81 with foil 82 secured thereto and a cap 83 and is similar to the preceding embodiment except that the collar 81, foil 82 and cap 83 are designed to be removed together.

The internal thread forms of the cap 83 each comprise a loose position 83A, a ramp 83B and rest position 83C. To tighten the cap 83 about the collar 81, the cap is rotated so that threadforms 81A of the collar ride up ramps 83B to the rest position 83C where the collar 81 is held firmly secured under a lip 80A of the container (as shown in FIG. 17A). To remove the closure means, the cap 83 is rotated in the opposite direction so the thread forms 81A ride down the ramps 83B to the loose position 83A. In this position, sufficient clearance C is provided between the thread forms of the cap 83 and collar 81 to permit the cap and collar both to be prised up off the container body 80, said clearance C allowing part of the collar 81 between slots 81A therein to flex outwardly sufficient to disengage from the lip 80A despite still being surrounded by the cap 83.

The above embodiments thus have the advantage that securement of the closure is effected by rotating the cap relative to the collar (without disturbing the foil which is bonded to the container) yet removal of the foil is effected progressively by a peeling action (rather than a rotary action) which lifts it away from the container as the collar and cap are prised off the container (once the cap has been rotated to the release position).

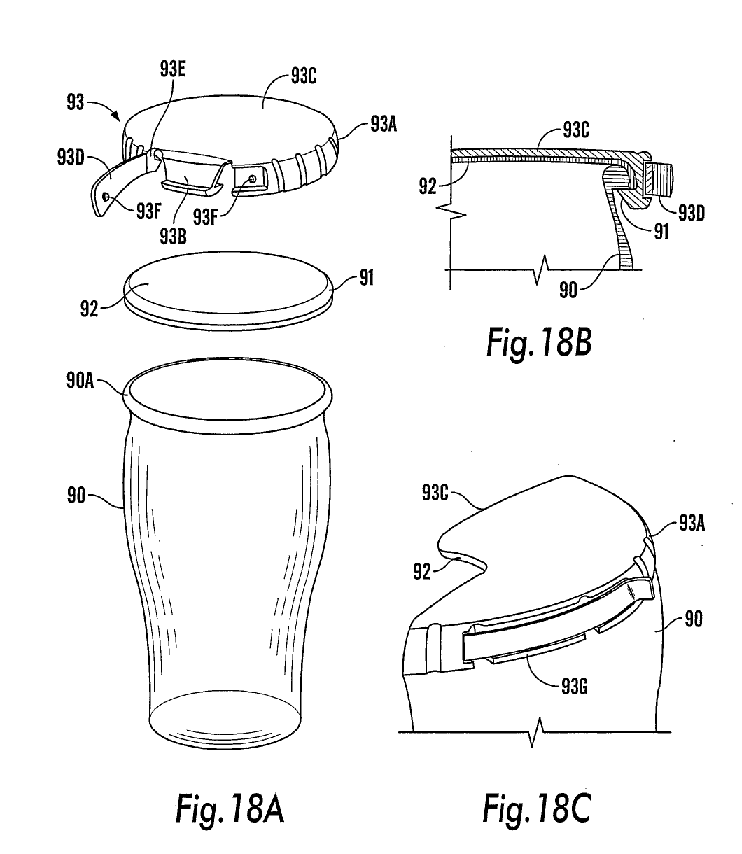

FIG. 18 shows another embodiment comprising a container 90, with lip 90A, a collar 91 with foil 92 attached thereto and cap 93 wherein the cap has a skirt portion 93A with an opening therein to permit the skirt to flex outwards. The opening is partially covered by a tongue portion 93B extending from a top part 93C of the cap. The opening can be closed by means of a tab 93D one end of which is attached to the skirt portion 93A at one end of the gap by a living hinge 93E and the other end of which can be attached to secured to the skirt portion 93A at the other end of the gap by mutually engageable parts 93F and/or by welding (after the cap 93 has been fitted over the collar 91).

FIG. 18B shows the cap in the closed position with the tab 93D secured across the gap. As shown, a projection 90G on the lower end of the tongue 93B is trapped beneath the tab 93D to secure the tongue 93B in position. The cap 93 is thus secured about the collar by tightening the skirt portion 93A thereof about the collar 91.

To remove the closure, the tab 93D has to be torn open (thus providing tamper evidence). The cap can then be prised off the collar by disengaging the tongue 93B from beneath the lip 90A so the collar can be prised off the container. As in the embodiments described above, the foil 92 is lifted at one edge and progressively peeled away from the container 90 as the collar is prised off the container 90.

In further variants of the arrangements described above, the cap can be designed to be installed onto the collar but to engage therewith in a manner that prevents its subsequent detachment from the collar. The container is thus designed so that, although the collar and cap may be installed separately during manufacture, they are removed as one component by the consumer (although they may subsequently be separated for re-use or recycling). To this end, the cap and collar may be provided with engagement means which ride over each other when the cap is rotated onto the collar but which engage when the cap is rotated in the opposite direction to prevent it being detached from the collar. One way of achieving this is described above in relation to FIGS. 6A and 6B and in relation to FIGS. 7-9.

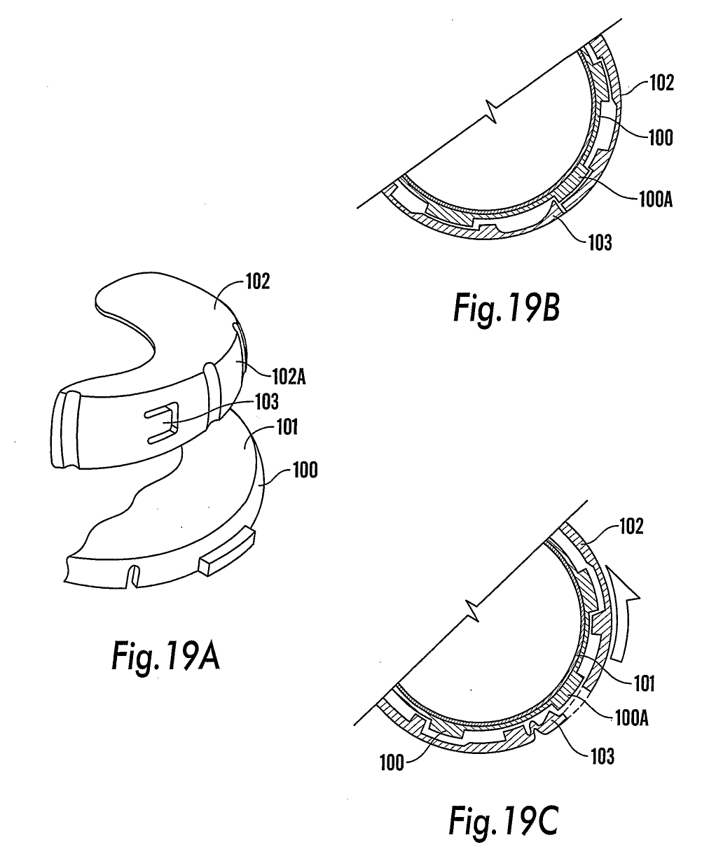

FIGS. 19A-19C illustrate another way of achieving this. This embodiment comprises a collar 100 with foil 101 attached thereto and cap 102 with a detent arm 103 projecting from the interior surface of the skirt 102A of the cap. The detent arm 103 rides over thread-like formation 100A of the collar 100 when the cap 102 is “screwed” onto the collar 100 in a clockwise direction and then engages with an edge of one of the thread-like formations 100A in the locked position as shown in FIG. 19B to prevent the cap 102 being unscrewed from the collar 100. One or more further such detent arms may be provided around the skirt 102A of the cap. The detent arm 103 may also be used to provide tamper evidence. The cap 102 may be provided with a weakened portion 102B which breaks when an attempt is made to unscrew the cap 102 from the collar 100 as shown in FIG. 19C.

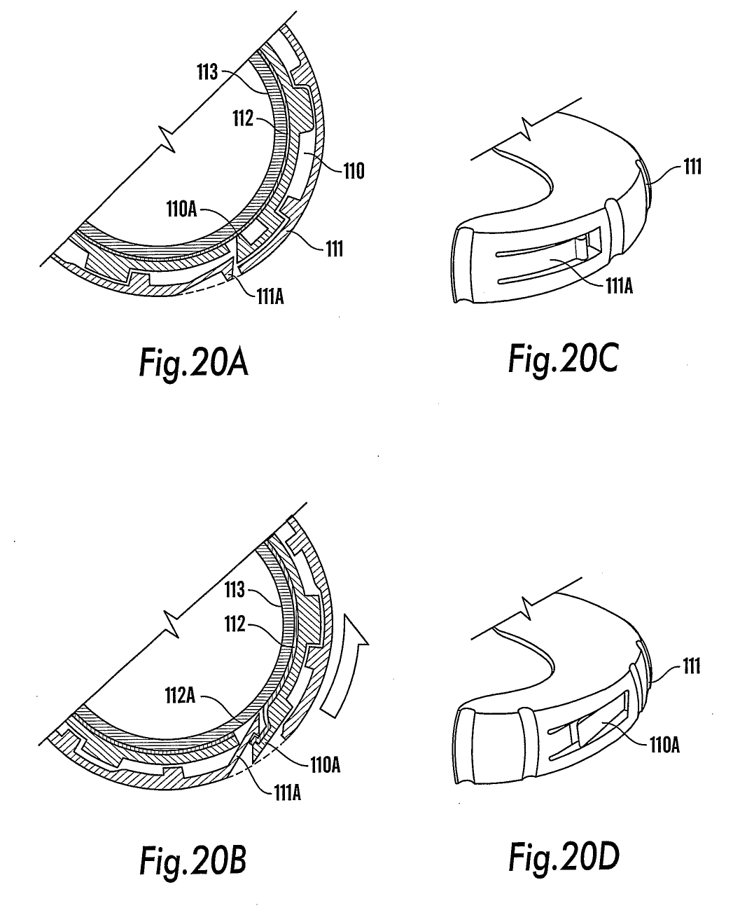

FIGS. 20A-20D illustrate an embodiment in which a collar 110 has a hook-like feature 110A which interacts with a hook-like feature 111A of a cap 111. FIGS. 20A and 20C show the parts after being rotated to the closed position and FIGS. 20B and 20D show the parts after the cap has been rotated to a venting position. The hook-like parts 110A, 111A engage each other to prevent further rotation of the cap 111 relative to the collar 110 and also act to break the foil 112 at point 112A so as to vent the container 113. Tamper evidence is also provided, e.g. by the appearance of part 110A as shown in FIG. 20D. The hook-like parts may be used to prevent the cap being detached from the collar. However, in another variant they may provide tamper evidence and/or venting as described although the cap may be arranged so it can be separated from the collar.

As previously described, once the cap has been rotated to the release position, the cap and collar can be prised off the container together and, as they are prised off, the foil is progressively peeled away from the container.

The above arrangements thus employ a rotary motion, via a screw thread, or a circumferential tightening to secure the closure to the container. However, although a partial unscrewing may be required to move the closure to a release position, removal of the closure, and in particular removal of the foil, is effected by a lifting action which peels the foil away from the container.

It will be appreciated that features of the various embodiments described above may be inter-changed to provide yet further arrangements.

1. A beverage container for the storage of a carbonated drink comprising a container body including an opening and removable closure means for closing said opening, the closure means comprising a foil which provides a gas tight seal for said opening and a collar for securing the foil to the container body.

2. A beverage container as claimed in claim 1 in which the foil is secured to the collar.

3. A beverage container as claimed in claim 2 in which the collar comprises a generally cylindrical member with a generally circular opening at each end thereof, the foil extending across one of said openings.

4. A beverage container as claimed in claim 1, 2 or 3 in which the collar is a snap-fit onto the container body.

5. A beverage container as claimed in claim 4 in which the container body has a projecting rim or lip around the opening thereof and the collar is a snap-fit over said rim or lip.

6. A beverage container as claimed in any preceding claim in which the closure means comprises a cap for fitting over the collar.

7. A beverage container as claimed in claim 6 in which the cap is secured to the collar by rotation relative thereto.

8. A beverage container as claimed in claim 7 in which the cap and collar have mutually engageable thread portions.

9. A beverage container as claimed in claim 8 in which when the cap is secured to the collar, in at least a first position, it prevents removal of the collar from the container and thus secures the closure means to the container body.

10. A beverage container as claimed in claim 9 in which when the cap is unscrewed to a second position, the collar can be prised off the container.

11. A beverage container as claimed in claim 10 in which the cap and collar remain secured together as the collar is prised off the container body.

12. A beverage container as claimed in any preceding claim in which the collar has a plurality of slots therein which enable it to expand to a sufficient extent to be fitted to and/or prised from the container body.

13. A beverage container as claimed in preceding claim in which the collar has one or more interruptions or gaps in its circumference so it can be radially expanded to be fitted to and/or removed from the container body and releasable fastening means for closing said gap and preventing radial expansion of the collar in the closed position.

14. A beverage container as claimed in any of claims 10 to 13 in which the foil is secured to the collar or to the cap so that, as the cap and/or collar is prised off the container, the foil is progressively peeled away from the container.

15. A beverage container as claimed in any preceding claim in which the collar comprises a skirt depending from the perimeter of a circular component, the collar and circular component together having the form of a cap.

16. A beverage container as claimed in claim 15 in which the skirt has at least one interruption or slot therein so the skirt can flex radially outwards to permit the collar to be fitted around the container body and releasable securing means for bridging the interruption or slot to prevent such outward radial flexing so as to secure the skirt about the container body.

17. A beverage container comprising a container body including an opening and removable closure means for closing said opening, the closure means comprising a foil which seals said opening, a cap for fitting to the body over the foil and a collar for fitting around the cap to secure the cap to the container body.

18. A beverage container as claimed in claim 17 in which the cap is a snap-fit with the container body but when the collar is in place around the cap, at least in a first position, it prevents the cap being prised off the container body.

19. A beverage container as claimed in claim 17 or 18 in which the collar and cap have mutually engaging thread portions, the collar being rotatable relative to the cap from a first, secured position to a second release position.

20. A beverage container as claimed in claim 19 in which in the second position, the collar allows outward flexing of at least part of the cap whereby the cap can be prised off the container body.

21. A beverage container as claimed in claim 20 in which the foil is secured to the cap so that as the cap is prised off the container body the foil is progressively peeled away from the container body.

22. A beverage container as claimed in any of claims 17-21 in which, in the secured position, the cap and collar are connected by tamper evident means.

23. Closure means for use to provide a beverage container as claimed in any preceding claim.

24. The use of a beverage container as claimed in any of claims 1-22 for containing a carbonated beverage.

25. A method of sealing a beverage container comprising a container body including an opening, the method comprising the steps of applying a foil to close said opening and applying a collar to secure the foil to the container body.
